(19) United States
(12) Patent Application Publication
(10) Pub. No.: US 2014/0375818 A1
(43) Pub. Date: Dec. 25, 2014

(54) DISTRIBUTING NETWORK CAMERA SYSTEM AND METHOD FOR OPERATING SAME

(71) Applicant: Electronics and Telecommunications Research Institute, Daejeon (KR)

(72) Inventors: Seung-Woo Lee, Daejeon (KR); Bhum Cheol Lee, Daejeon (KR); Young Ho Park, Daejeon (KR); Jung Hee Lee, Daejeon (KR); Kang Il Choi, Daejeon (KR); Sang-Min Lee, Daejeon (KR)

(73) Assignee: Electronics and Telecommunications Research Institute, Daejeon (KR)

(21) Appl. No.: 14/080,657

(22) Filed: Nov. 14, 2013

(30) Foreign Application Priority Data
Jun. 24, 2013 (KR) 10-2013-0072415

(51) Int. Cl. H04N 7/18

(52) U.S. Cl. CPC H04N 7/181
USPC 348/159

(57) ABSTRACT

A distributed network camera system includes a network camera configured to be connected to a network; and a distributed media server configured to process video data provided by the network camera in a network node which is located close to the network camera. Further, the distributed network camera system includes a centralized management server configured to be connected to the network and manage the connection establishment between the distributed media server and the network camera and the operation state of the distributed media server.

### CROSS-REFERENCE TO RELATED APPLICATION(S)

The present invention claims priority of Korean Patent Application No. 10-2013-0072415, filed on Jun. 24, 2013, which is incorporated herein by reference.

### FIELD OF THE INVENTION

The present invention relates to a method for distributing centralized camera servers on a network to provide high-definition network cameras and DVRs (Digital Video Recorders), and more particularly, to a distributed network camera system for distributing camera servers and storage devices that are arranged intensively on a network to network cameras or a user closely so as to more efficiently process a high quality or multi video streams that are produced from the network cameras connected via the network, so that the high quality or multi video streams can be delivered to the user in real time, and method for operating the system.

### BACKGROUND OF THE INVENTION

In general, in order to monitor facilities such as particular buildings, convenient facilities or the like, since a security camera system such as a CCTV (a closed TV) had been introduced in the art in which video cameras, monitors, and video recording devices are connected one another in a closed-network, in recent years, there is an increasing tendency of methods in which cameras, camera servers and storage devices are interconnected one another through an open network such as an IP network.

In particular, remote users having a network connection are able to directly access the cameras that have also the network connection, and also to have access to the cameras situated in a remote location via the Internet.

Such a conventional technique may be embodied as a method shown in FIG. 1, in which video data are acquired by network cameras situated in remote locations and then is stored in data storage devices on servers situated in the remote locations via the Internet. The video data that has been processed by the servers and stored in the storage devices is delivered to the user. In typical, a data transfer scheme based on an HTTP is mainly employed to transfer the video data from the cameras to the camera servers and transmit the video data that has been processed by the camera servers and stored in the storage devices to the user. Thus, the cameras, the camera servers, the storage devices, and the user use an HTTP-based application program interfaces.

Accordingly, a web application camera server situated in the remote location co-exists with a video data storage device, and a user can access the video data that is stored in the data storage device of a web server using a client application program of an agent function having a web access capability. Consequently, the user needs not to equip with the storage device that receives and stores the video data directly, but rather has access to the video data using the server and the storage device situated in the remote location.

In recent years, a variety of services are provided through the Internet using a system such as an Internet data center (IDC) in which a plurality of servers and storage devices are centrally configured in large scale. In this case, a user needs not to individually build servers and storage devices, which is effective in a maintenance cost and installation cost that are saved. Therefore, in case where the Internet data center is applied to a network camera system, the equipments such as servers and storage devices that are furnished in the Internet data center may be expected to utilize as the equipments such as camera servers and video storage devices for the network camera system.

FIG. 1 shows an example of a network camera system constituted by utilizing servers and storage devices in an Internet data center in accordance with a related art.

In a related art technique as shown in FIG. 1, a network camera system is constituted with a user terminal 100, an IDC (Internet data center) 106 in which a server and a storage device are included, a plurality of network cameras 102 and 104 that are connected one another via a network 108. The components in the network camera system are connected one another through the network such as the Internet, which offers a high system scalability as much. Further, any remote users enable video data to store in the storage device through the use of a server application program and thus perform an optimization and a resource management of the entire system. Accordingly, such a network camera system has an enhanced reliability and efficiency relative to an existing network camera system. In addition, the network camera system employs an existing open IP network, which leads to a low network construction expense.

However, the related art technique has a problem as follows.

First of all, the video data captured through the network cameras 102 is transferred to a high-capacity centralized server and storage device situated in a remote location via an existing IP network. Specifically, as illustrated in FIG. 1, video streams captured by the network cameras 102 is typically transferred to the centralized IDC 106 including the centralized server and storage device via an access network and a core/edge network. In this case, a wireless user or a wire user needs to pass the access network and core/edge network in order to get the video stream that is stored in or processed by the IDC 106.

Therefore, when a real-time video stream is requested by the user, the video stream is transferred to the server and storage device through the core/edge network and is then processed and stored by the server and storage device before being forwarded to the user through the core/edge network again. In such a case, the user suffers from a long latency of the video stream when the user attempts to receive the video stream. Further, in case where the user tries to directly operate the network cameras 102 and 104 in real time, such a long latency time may cause the propagation and response times of a control signal for the network camera's response to be lengthened. This may bring about an unexpected result.

### SUMMARY OF THE INVENTION

In view of the above, the present invention provides a distributed network camera system for distributing camera servers and storage devices that are arranged intensively on a network to cameras or a user closely so as to efficiently process and store a high quality or multi video streams and manage the cameras, the camera servers and the storage devices so that the high quality or multi video streams can be effectively delivered to the user in real time, and method for operating the system.

Further, the present invention provides a distributed network camera system, when distributing camera servers that are arranged intensively on a network to provide high-definition network cameras and DVRs, for distributing camera servers and storage devices on a network to cameras or a user closely so as to more efficiently process a high quality or multi video streams that are produced from the cameras connected to the network, so that the high quality or multi video streams can be delivered to the user in real time, and method for operating the system.

In accordance with a first aspect of the present invention, there is provided a distributed network camera system including: a network camera configured to be connected to a network; a distributed media server configured to process video data provided by the network camera in a network node which is located close to the network camera; and a centralized management server configured to be connected to the network and manage the connection establishment between the distributed media server and the network camera and the operation state of the distributed media server.

Further, the distributed media server may be configured to: process and store the video data input from the network camera; and upon a receipt of a request of the video data from a user terminal connected to the network, transmit the video data to the user terminal through a network node to which the user terminal is connected.

Further, the distributed media server may be configured to: when the user terminal makes a request for the video data, check the location where the user terminal is connected to the network; when it is checked that the user terminal is connected to a network node that is located close to the distributed media server, transmit the video data with high quality; and when it is checked that the user terminal is not connected to a network node that is located close to the distributed media server, transmit the video data with low quality.

Further, the distributed media server may be configured to: when there is a functional disorder of the distributed media server, deliver its own operational information to another distributed media server connected to a neighboring network node that serves as a virtualized management server so that the another distributed media server can perform the processing of the video data from the network camera.

Further, the operational information may comprise a resource configuration, a network connection state, or stored video data information for the distributed media server having the functional disorder.

Further, the distributed media server may comprise a media storage device that stores the video data.

Further, the distributed media server may be located in association with the network node, which is located close to the network camera, on the network in a distributed manner.

Further, the video data may comprise high quality video data or video/audio stream data.

Further, the distributed media server may be configured to process the video/audio stream data on a stream basis through data virtualization.

Further, the network node may comprise a switch or a router disposed between the distributed media server and the network camera.

Further, the user terminal may have a data communicating capability with the distributed media server through the network connection.

Further, the user terminal device may comprise a personal computer (PC), a notebook computer, a tablet PC, a PDA, or a smart phone.

In accordance with a second aspect of the present invention, there is provided a method for operating a distributed network camera system. The method includes receiving, at a distributed media server, video data supplied from a network camera connected to a network, wherein the distributed media server is connected to a network node that is located close to the network camera; processing, at a distributed media server, the video data to store the processed video data; receiving a request of the video data from a user terminal through the network; and transmitting, at a distributed media server, the video data to the user terminal device.

Further, the transmitting the video data may comprise: when the user terminal makes a request for the video data, checking the location where the user terminal is connected to the network; when it is checked that the user terminal is connected to a network node that is situated close to the distributed media server, transmitting the video data with high quality; and when it is checked that the user terminal is not connected to a network node that is situated close to the distributed media server, transmitting the video data with low quality.

Further, the processing the video data to store the processed video data may comprise processing the video/audio stream data on a stream basis through data virtualization.

Further, the distributed media server may be configured to: when there is a functional disorder, delivering its own operational information to another distributed media server connected to a neighboring network node that serves as a virtualized management server so that the another distributed media server can perform the processing of the video data from the network camera.

Further, the operational information may comprise a resource configuration, a network connection state, or stored video data information for the distributed media server having the functional disorder.

Further, the distributed media server may be located in association with the network node, which is located close to the network camera, on the network in a distributed manner.

Further, the video data may comprise high quality video data or video/audio stream data.

Further, the network node may comprise a switch or a router disposed between the distributed media server and the network camera.

As set forth above, in accordance with an embodiment of the present invention, it is possible to distribute the camera servers and the storage devices on the network to the cameras or the user closely so as to more efficiently process the high quality or multi video streams and manage the cameras, the camera servers and the storage devices, thereby effectively delivering the high quality or multi video streams to the user in real time.

### BRIEF DESCRIPTION OF THE DRAWINGS

The above and other objects and features of the present invention will become apparent from the following description of the embodiments given in conjunction with the accompanying drawings, in which:

FIG. 1 shows an example of a centralized network camera system in accordance with a related art;

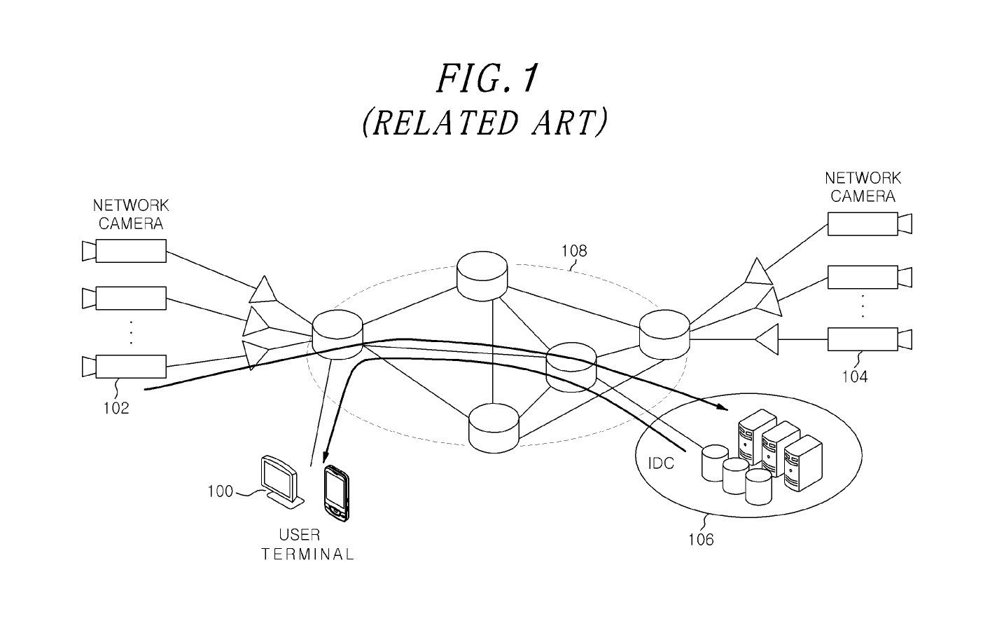

FIG. 2 is a configuration diagram of a distributed network camera system in accordance with an embodiment of the present invention;

FIG. 3 is a conceptual diagram of transmitting image data in a distributed network camera system that is connected to a single network node in accordance with an embodiment of the present invention;

FIG. 4 is a conceptual diagram of transmitting image data in a distributed network camera system that is connected to a plurality of network nodes in accordance with an embodiment of the present invention;

FIG. 5 is a conceptual diagram of transmitting image data in a distributed network camera system that is connected to a plurality of network nodes in accordance with another embodiment of the present invention;

FIG. 6 is a configuration diagram of a distributed network camera system for a centralized management in accordance with an embodiment of the present invention; and

FIG. 7 is a configuration diagram of a distributed network camera system for a distributed management in accordance with an embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

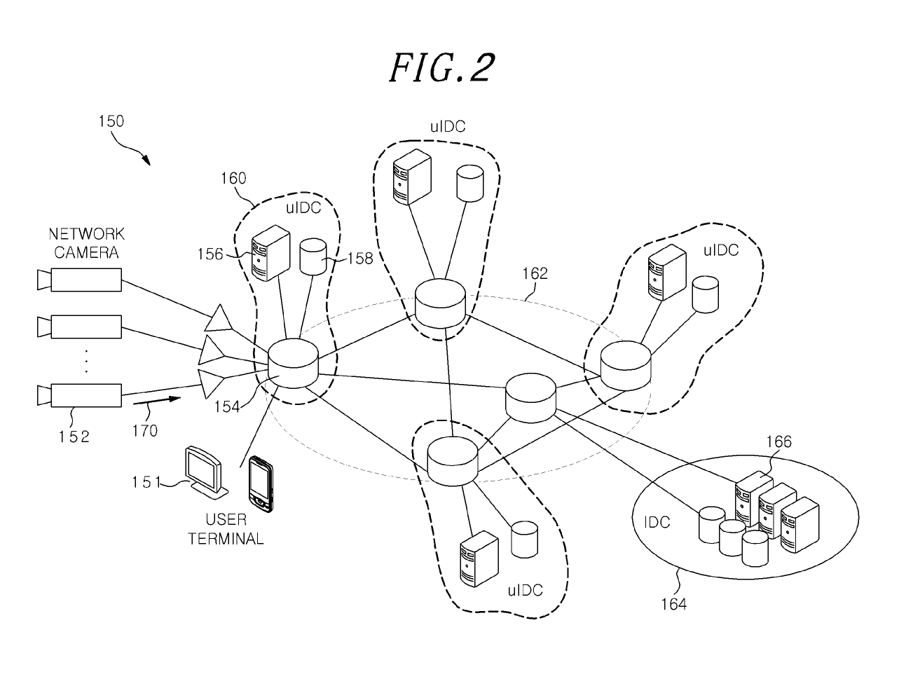

FIG. 2 illustrates a distributed network camera system for forwarding high quality images or multi video streams that are produced from cameras that are connected via a network in accordance with an embodiment of the present invention.

Referring to FIG. 2, a distributed network camera system 150 includes a plurality of network cameras 152, a plurality of network nodes 154 each having a switch, router and the like that serves as a network connection device, a plurality of undersized Internet data centers (uIDCs) 160 and a centralized IDC 164. Each of the uIDCs includes a distribute media server 156 and a media storage device 158.

First, the network cameras 152 serve to provide high quality video images and audio data 170 through a network 162. In case of the high quality video images, video streams that are provided have various resolutions, video compression formats, video rate, and others.

For example, the video compression formats may be MJPEG, MPEG-4, H.264, and so on. These compression formats have merits and demerits, and there are numerous selection criteria such as latency, video image quality, bandwidth consumption, the number of cameras, and others. In view of the use of a bandwidth, the MPEG-4 and H.264 are efficient compression formats that are most widely used today. These formats are a compression method that is best available to save the bandwidth and the storage device. Meanwhile, the MJPEG offers an excellent video quality but has a disadvantage that it occupies a large bandwidth. Therefore, it may be a compression method adequate for the links that have a low data rate since frames are independent one another.

Compared to the MJEP, the H.264 uses only about ⅙ bandwidth and thus may be the most optimal choice for optimization of a bandwidth and a storage device.

Generally, the network cameras 152 are able to transmit digital video data on a TCP/IP network. In case that the network cameras are implemented with analog cameras, the network cameras require an encoder that converts analog signals into digital signals and an interface that allows a connection to an IP network.

The uIDCs 160 presented in the configuration of the embodiment are distributed and located in relation to a network node 154 in the vicinity of the network cameras 152. Each of the uIDCs 160 includes the distributed media server 156, which processes video and audio streams, and the media storage device 158, which stores the processed video and audio streams and adjusts a transfer path of the video and audio streams, inclusive of the network node 154 having a switch and router capability.

The distributed media server 156 is responsible for storing and processing high quality images via a physical or virtual digital video recorder (DVR).

The virtual DVR is intended to virtualize a physical media server and media storage device to process and store high quality images. Therefore, a user may process and store the high quality images that are produced from the network cameras 152 in the virtualized media server and the virtualized storage device more efficiently. Further, the high quality images may be processed and stored in the virtualized media server and the virtualized storage device on a stream basis that are produced by the network cameras 152, and the high quality image to be processed and stored on a network camera basis using the virtualized media server and the virtualized storage device.

By way of the virtualization, it is possible to physically share the resources such as the servers and the storage devices relative to the physical media server and physical storage devices, thereby increasing a practical use. In addition, it is also possible to reduce the number of the physical media servers and physical storage devices to be managed, thereby lowering a management cost.

The distributed media server 156 and the network node 154 are connected via the network 162. Also, a set of the network cameras 152 are connected to the uIDC 160 containing the distributed media server 156 and the media storage device 158 and the network node 154 with the switch and router capability through the network 162.

The network 162 is constituted with switches, routers and others that serve as a network connection device of two layers or more. The network 162 may be categorized into an access network, core/edge network, etc. depending on its location. The access network may refer a network that is intended to connect the user terminal 151 to a backbone communication network. The core network may represent a large-scale high-speed backbone network for providing high-capacity, long-distance data transmission services.

Typically, the user is able to have access to the IDC 164 provided with high-capacity storage devices and a plurality of high performance servers through the access network and the core/edge network using the user terminal 151. Also, the network cameras 152 transmit the video data that is captured to the centralized IDC 164 through the access network and the core/edge network.

In the centralized IDC 164, a centralized management server 166 manages the state of the network cameras 152, a network connection establishment of the distributed media servers 156 and the network cameras 152 and the like in a centralized manner.

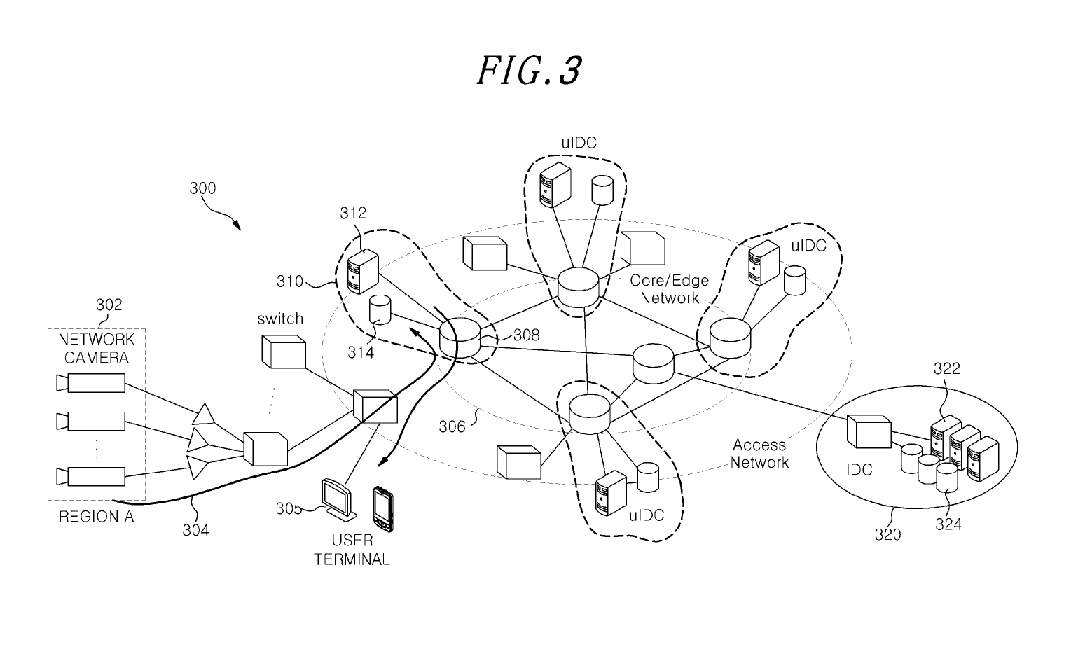

FIG. 3 illustrates a distributed network camera system 300 having a set of network cameras that are connected to a single network node in accordance with an embodiment of the present invention. FIG. 3 may stand for one embodiment in which a network camera system is constructed for the private purpose by an individual user.

For example, a video stream captured by the network cameras 302 located in a region A is sent to a uIDC 310, which is situated near regionally to the region A, among the uDICs that are dispersed across the network 306 through a network node 308.

As such, in accordance with an embodiment of the present invention, in lieu of storing the captured video streams into the centralized IDC 320, the captured video streams are transmitted to the distributed media server 312 and media storage device 314 in the uIDC 310 located in a distribute manner on the network 306, is processed by the distributed media server 312 and then stored in the storage device 314.

Assuming that a user terminal 305 wants to receive a video stream captured in the region A, for a conventional method, the user terminal receives the video stream that has been processed in a central management server 322 in the IDC 320 and stored in the media storage device 324 in the IDC 320. In contrast, in the embodiment of the present invention, the user terminal receives the video stream that has been processed in a distributed media center 312 in the uIDC 310 and stored in the media storage device 314 in the uIDC 310, thereby relatively reducing the latency of the video stream.

In order to deliver a real-time video stream to the user terminal 305 so as to represent on a screen in real time, it is required to shorten the time to deliver the video stream through the network 306. In addition, in order to realize a PTZ (Pan, Tilting, and Zoom) function on the screen monitored in real time, instruction to execute the PTZ function should be directed to the network server and network cameras within as short a time as possible in response to the screen and the network cameras should carry out the instruction. To accomplish it, the use of the distributed media center 312 and the media storage device 314 enables the delivery of a control signal to control the network cameras 302 within a short time period.

In this case, the distributed media center 312 in the uIDC 310 that is distributed is virtualized so as to process video stream and video data. The uIDC 310 includes one or more virtualized servers and one or more virtualized storage devices that are connected with each other via a network connection device of two layers or more. The virtualized servers are able to process the video stream provided from the network cameras 302.

The user terminal 305 is a device to receive the video stream and may be a personal computer or a notebook computer to receive the video stream via a wired network or devices such as PDAs, mobile telephones and smart phones to receive the video stream via a wireless network. In particular, for the wireless network, a mobile telecommunication such as 3G, 4G, etc. may be utilized as well as a wireless LAN communication such as WiFi communication.

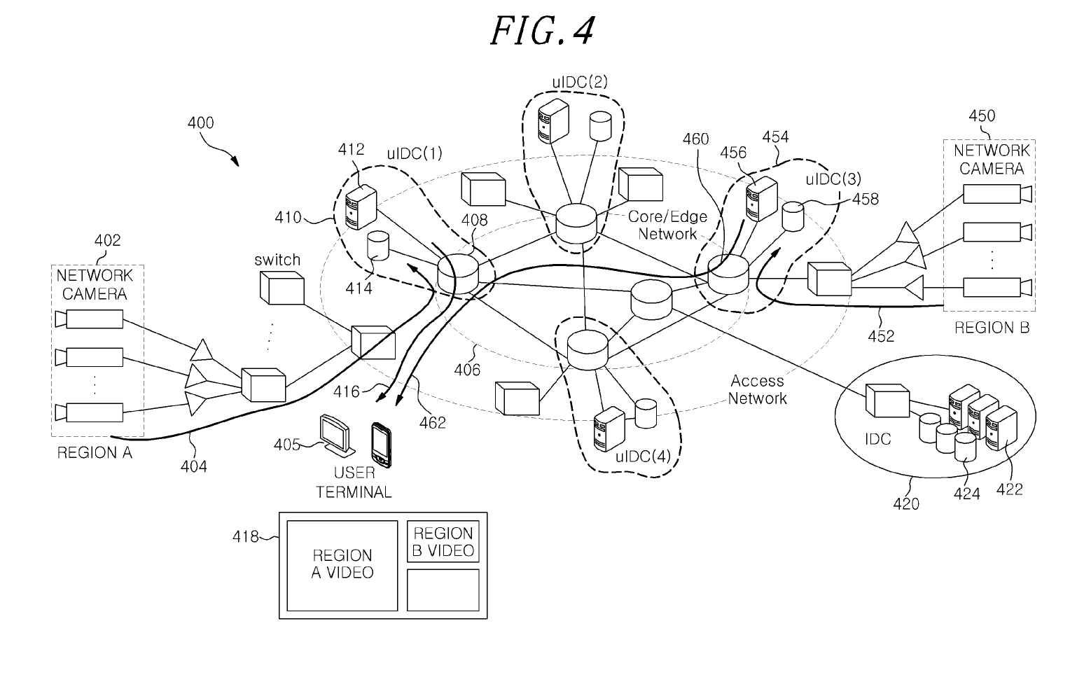

FIG. 4 illustrates a distributed network camera system 400 having a set of network cameras that are connected to a plurality of network nodes in accordance with an embodiment of the present invention. FIG. 4 may stand for one embodiment in which a network camera system is constructed for the enterprise purpose by an enterprise user.

Referring to FIG. 4, a distributed media server 412 and a media storage device 414 that process video stream 404 captured by a set of network cameras 402 situated in a region A are deployed in a first uDIC 410; and a distributed media server 456 and a media storage device 458 that process video stream 452 captured by a set of network cameras 450 situated in a region B are deployed in a third uDIC 454.

In such a case, a video stream 404 captured in the region A is sent to the first uIDC 410 which is nearest to the network cameras 402 situated in the region A through a network node 408 and then processed by the virtualized distributed media server 412 in the first uIDC 410. Meanwhile, a video stream 452 captured in the region B is sent to the third uIDC 454 which is nearest to the network cameras 450 situated in the region B through a network node 460 and then processed by the virtualized distributed media server 456 in the third uIDC 454.

A video stream 416 processed and stored in the first 410 is sent to a screen 418 on the user terminal 405 through the network node 408 which is nearest to the user terminal 405 situated in the region A, whereas a video stream 462 processed and stored in the third uIDC 454 needs to be passed through the core/edge network 406 in order to be transmitted to a screen 418 on the user terminal 405 that is situated in the region A, which requires a long transmission time. Consequently, the video stream captured in the region A is transmitted to the screen 418 of the wired or wireless user terminal 405 situated in the region A in a high quality in real time, whereas the video stream captured in the region B is transmitted to the user terminal 405 in a poor quality with a certain latency.

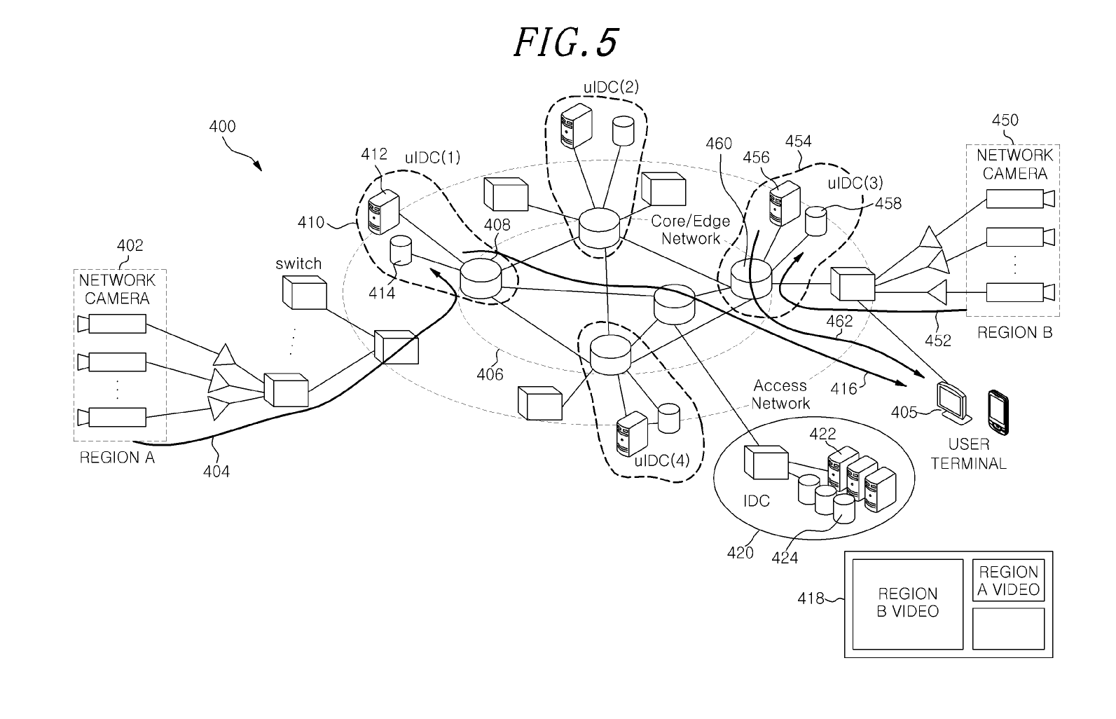

FIG. 5 illustrates a distributed network camera system 400 having a set of network cameras that are connected to a plurality of network nodes in accordance with another embodiment of the present invention.

FIG. 5 may stand for one embodiment in which a network camera system is constructed for the enterprise purpose by an enterprise user. Moreover, FIG. 5 illustrates a case where a user terminal 405 situated in the region A moves to another region B and then receives the video streams captured by the cameras 402 and 450 in the regions A and B, respectively.

Distributed media server 412, 456 and distributed media server 414, 458 that process and store a video stream is the same as those in FIG. 4. The video stream 404 captured in the region A is processed in the distributed media server 412 in the first uIDC 410, whereas the video stream 452 captured in the region B is processed in the distributed media server 456 in the third uIDC 454.

The video stream 462 processed and stored in the third uIDC 454 is sent to the screen 418 on the user terminal 405 through the network node 460 which is nearest to the user terminal 405 situated in the region B, whereas the video stream 416 processed and stored in the first uIDC 410 needs to be passed through the core/edge network 406 in order to be transmitted to the user terminal 405 which is situated in the region A, which requires a long transmission time.

Consequently, the video stream captured in the region B is transmitted to the screen 418 of the wired or wireless user terminal 405 situated in the region B in a high quality in real time, whereas the video stream captured in the region A is transmitted to the user terminal 405 in a poor quality with a certain latency.

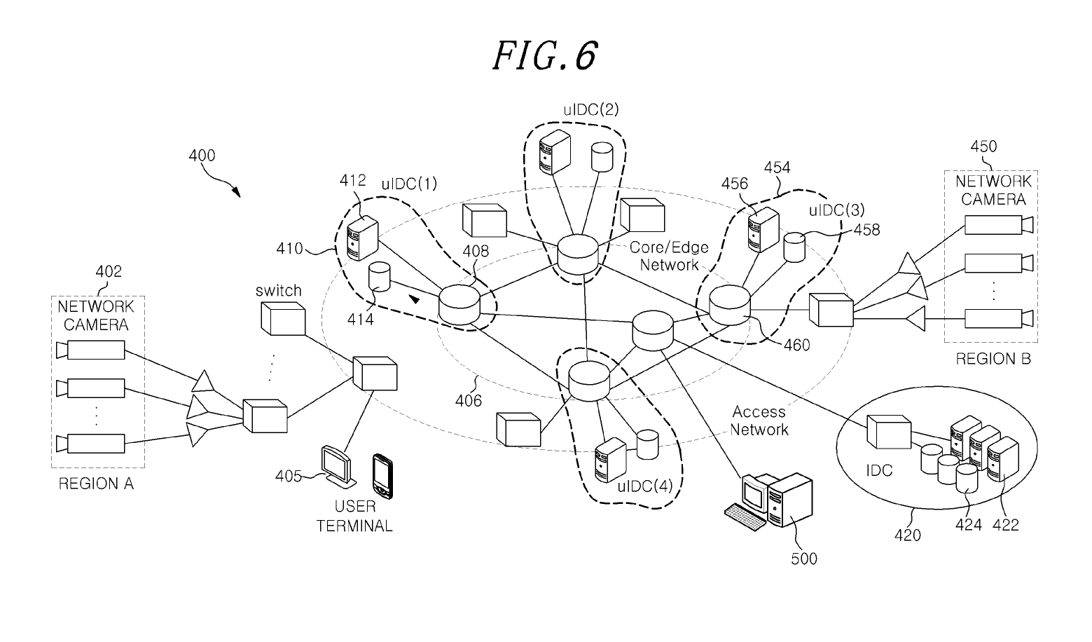

FIG. 6 illustrates a distributed network camera system 400 for a centralized management in accordance with another embodiment of the present invention. FIG. 6 may stand for one embodiment of the distributed network camera system in which a manager 500 serving as a centralized management server generally manages network cameras, servers and storage devices.

Referring to FIG. 6, the manager 500 of the distributed network camera system may access an IDC 420 including a central management server 422 and a storage device 424 through a core/edge network 406.

The central management server 422 maintains information about the definition, configuration, connection state and the like for resources such as the network cameras 402 and 450, the network nodes 408 and 460, the distributed media servers 412 and 456, and the media storage devices 414 and 458, and forwards the information to a terminal of the manager 500.

In addition to the information as set forth above, it is necessary to manage information such as compression state for the video image. Once this information is forwarded to the manager 500 from the central management server 422, the central management server 422 requests video images related to the information from the distributed media servers 412 and 456 and the media storage devices 414 and 458 based on the information, which in turn forward the requested video images to the manager 500 through the core/edge network 406.

In this case, if real-time high quality video images are requested, the distributed media servers 412 and 456 request the network cameras 402 and 450 to transmit the high quality video images in real time to the distributed media servers 412 and 456 through the core/edge network 406, and the network cameras 402 and 450, in response to the request, transmit corresponding high quality video images through the core/edge network 406. In this case, the video images flow through the network nodes 408 and 456, which are close to the network cameras 402 and 450, and the distributed media servers 412 and 456 and the media storage devices 414 and 458 that are connected to the network nodes 408 and 460 to the manager 500.

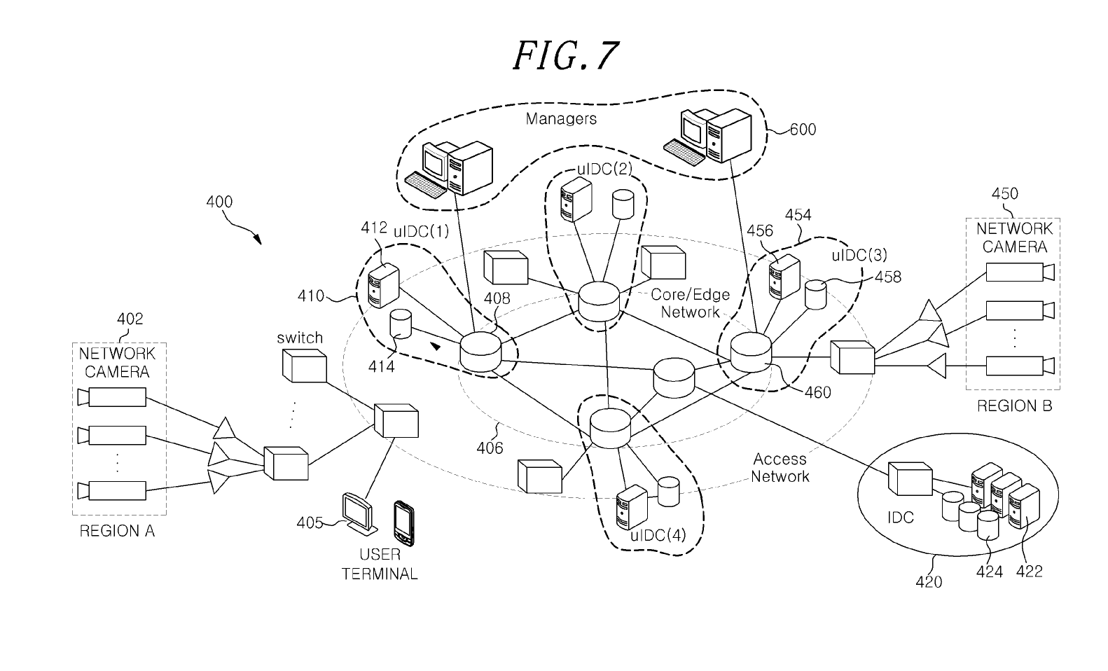

FIG. 7 illustrates a distributed network camera system for a management of cameras and camera servers that are connected to a single or a plurality of network nodes in accordance with an embodiment of the present invention.

FIG. 7 may stand for one embodiment of the distributed network camera system in which managers serving as distributed management servers 600 manage network cameras, distributed media servers and media storage devices.

Further, in FIG. 7, the management server 600 is dispersed regionally. In this embodiment, similarly to the centralized management server 422, the management server 600 that are dispersed regionally function to manage the resource configuration, network connection state, and image information.

In this embodiment, it is assumed a scenario that each one of distributed media servers 412 and 456 in uIDCs 410 and 454 is virtualized and used as a management server 600.

When there occurs a situation that the virtualized distributed media server in any uDIC is no longer served as the management server 600 owing to a functional disorder or a power failure, the virtualized server environment needs to be migrated to a virtualized distributed media server in another uDIC. This means that the contents and environment managed by an affected virtualized server in one uDIC is migrated to a virtualized server in the another uDIC and the information stored and managed in a storage device in the uDIC is also copied in a storage device in the another uDIC in order to reconstruct the same server environment without discontinuing the compression and process of the video data captured in a certain region.

Therefore, in such a case where the role of the management server 600 is migrated to the another uDIC, a manager maintains information about the definition, configuration, connection state and the like of resources such as the network cameras, network nodes, media servers and media storage devices and forwards the information to the terminal of the manager using the virtualized management server in the another uIDC. Along with the information as set forth above, it is also necessary to manage information such as compression state for the video image. After the information that has been migrated to the virtualized management server in the another uIDC is relayed to the manager through the management server, the management server requests video image related to the information from the media server and the media storage device based on the information, and the media servers and the media storage device then forward the requested video image to the manager through the network.

As an example, it is assumed that each one of the distributed media servers 412 and 456 in the first and third uIDCs 410 and 454 is virtualized and used as a management server 600. In case where the virtualized distributed media server 465 in the third uIDC 454 is no longer served as the management server 600 owing to a functional disorder or power failure, the environment of the virtualized distributed server 456 needs to be migrated to the virtualized distributed media server 412 in the first uDIC 410.

In this case, in order to reconstruct the same server environment so that the compression and processing task of the video data captured in the certain B is not discontinued, the contents and environment managed by the distributed media server 456 in the third uDIC 454 is migrated to the virtualized distributed media server 412 in the first uDIC 410 and the information stored in the storage device 458 in the third uDIC 454 is also copied into the storage device 414 in the first uIDC 410.

Therefore, the role of the management server 600 is migrated to the first uIDC 410 from the third uIDC 454, and the information about resources such as the network cameras 450, the network node 460, the distributed media server 456 and the media storage device 458 is copied using the virtualized distributed media server 412 as the management server. The manager then performs a management with respect to the network cameras 450, the distributed media server 456 and the media storage device the media storage device 458 through the use of the distributed media server 412 which is qualified as the management server.

As mentioned above, the embodiment of the present invention distributes the camera servers and the storage devices that are arranged intensively on a network to the cameras or the user closely so as to more efficiently process and store the high quality or multi video streams and manages the cameras, the camera servers and the storage devices, thereby effectively delivering the high quality or multi video streams to the user in real time.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A distributed network camera system comprising:
a network camera configured to be connected to a network;
a distributed media server configured to process video data provided by the network camera in a network node which is located close to the network camera; and
a centralized management server configured to be connected to the network and manage the connection establishment between the distributed media server and the network camera and the operation state of the distributed media server.

2. The distributed network camera system of claim 1, wherein the distributed media server is configured to:
process and store the video data input from the network camera; and
upon a receipt of a request of the video data from a user terminal connected to the network, transmit the video data to the user terminal through a network node to which the user terminal is connected.

3. The distributed network camera system of claim 2, wherein the distributed media server is configured to:
when the user terminal makes a request for the video data, check the location where the user terminal is connected to the network;
when it is checked that the user terminal is connected to a network node that is located close to the distributed media server, transmit the video data with high quality; and
when it is checked that the user terminal is not connected to a network node that is located close to the distributed media server, transmit the video data with low quality.

4. The distributed network camera system of claim 1, wherein the distributed media server is configured to:
when there is a functional disorder of the distributed media server, deliver its own operational information to another distributed media server connected to a neighboring network node that serves as a virtualized management server so that the another distributed media server can perform the processing of the video data from the network camera.

5. The distributed network camera system of claim 4, wherein the operational information comprises a resource configuration, a network connection state, or stored video data information for the distributed media server having the functional disorder.

6. The distributed network camera system of claim 1, wherein the distributed media server comprises a media storage device that stores the video data.

7. The distributed network camera system of claim 1, wherein the distributed media server is located in association with the network node, which is located close to the network camera, on the network in a distributed manner.

8. The distributed network camera system of claim 1, wherein the video data comprises high quality video data or video/audio stream data.

9. The distributed network camera system of claim 8, wherein the distributed media server is configured to process the video/audio stream data on a stream basis through data virtualization.

10. The distributed network camera system of claim 1, wherein the network node comprises a switch or a router disposed between the distributed media server and the network camera.

11. The distributed network camera system of claim 2, wherein the user terminal has a data communicating capability with the distributed media server through the network connection.

12. The distributed network camera system of claim 11, wherein the user terminal device comprises a personal computer (PC), a notebook computer, a tablet PC, a PDA, or a smart phone.

13. A method for operating a distributed network camera system, the method comprising:
receiving, at a distributed media server, video data supplied from a network camera connected to a network, wherein the distributed media server is connected to a network node that is located close to the network camera;
processing, at a distributed media server, the video data to store the processed video data;
receiving a request of the video data from a user terminal through the network; and
transmitting, at a distributed media server, the video data to the user terminal device.

14. The distributed network camera system of claim 13, wherein said transmitting the video data comprises:
when the user terminal makes a request for the video data, checking the location where the user terminal is connected to the network;
when it is checked that the user terminal is connected to a network node that is situated close to the distributed media server, transmitting the video data with high quality; and
when it is checked that the user terminal is not connected to a network node that is situated close to the distributed media server, transmitting the video data with low quality.

15. The method of claim 13, wherein said processing the video data to store the processed video data comprises processing the video/audio stream data on a stream basis through data virtualization.

16. The method of claim 13, wherein the distributed media server is configured to:
when there is a functional disorder, delivering its own operational information to another distributed media server connected to a neighboring network node that serves as a virtualized management server so that the another distributed media server can perform the processing of the video data from the network camera.

17. The method of claim 16, wherein the operational information comprises a resource configuration, a network connection state, or stored video data information for the distributed media server having the functional disorder.

18. The method of claim 13, wherein the distributed media server is located in association with the network node, which is located close to the network camera, on the network in a distributed manner.

19. The method of claim 13, wherein the video data comprises high quality video data or video/audio stream data.

20. The method of claim 13, wherein the network node comprises a switch or a router disposed between the distributed media server and the network camera.
